(19) United States
(12) Patent Application Publication
(10) Pub. No.: US 2004/0187887 A1
(43) Pub. Date: Sep. 30, 2004

(54) Disposable angled toothbrush, periodontal aid and floosing device

(76) Inventor: Nancy Ruth Beckman, New Market, AL (US)

Correspondence Address: Nancy R. Beckman, 1078 Upper Hurricane Rd, New Market, AL, 35761, US

(21) Appl. No.: 10/394,182

(22) Filed: Mar. 24, 2003

(51) Int. Cl. A46B 9/04; A61C 15/00; A61C 15/04

(52) U.S. Cl. 132/309; 15/106; 15/167.1

(57) ABSTRACT

A four-component, complete dental item comprises a small, sleek, angled toothbrush connected by a handle portion which is flexible enough to allow carrying inside a pocket or package without breakage, to an angled flossing device which has an attached periodontal brush. The toothbrush has a small head with two rows of ¼″ to ½″ length bristles. The flossing device comprises fork-like prongs that hold a piece of dental floss under tension. The periodontal brush (which can be any of the various shaped cylindrical brushes) is attached to the flossing device. The entire device can be covered with a sanitary, thin plastic sealed cover and a dry dentifrice can be applied to the toothbrush.

### BACKGROUND OF THE INVENTION

This invention relates to a sleek, compact, disposable toothbrush, periodontal brush and flossing device packaged in a convenient unit that can be used by just one hand. The item is designed to provide a complete and simplified way of removing all plaque from the user's teeth with the use of one hand even if the user has braces, periodontal disease, crooked teeth and bridges. The device has a small toothbrush which is angled to provide the greatest access to the back teeth without interference by the flossing and periodontal end. The flossing/periodontal brush end is also angled to provide greater ease in use without interference by the toothbrush end. The attached periodontal brush is flexible so as to be moved in any direction to aid in the ease of plaque removal with the brush and also the flossing device.

Various disposable tooth cleaning devices for the reduction of dental and periodontal disease are known, and typical prior art devices are shown in U.S. Pat. Nos. 3,165,776; 4,503,871; 4,522,524; 4,530,129; 4,588,089; 4,865,481; 4,499,176 and 5,184,719. None of these devices provide a periodontal aid for the cleaning of bridge areas, braces, periodontal defects (gaps between the teeth) and crooked teeth. Also, none of these prior art devices provide a packaging around the entire device. A need does exist for the complete periodontal care provided in this angled, sleek, compact, portable, easy-to-use, inexpensive, sanitary and readily available for use anytime item.

Many disposable dental cleaning devices work more efficiently when the gums are healthy and the teeth are normal in shape and position. The addition of the periodontal brush allows timely, easy cleaning of those hard-to-clean areas where normal floss will not reach without use of more time, more effort and both hands.

### THE INVENTION

The disposable complete care dental device is provided for maintaining dental hygienic care when time, location and physical constraints or added tasks prohibit or make inconvenient the use of traditional toothbrushes, toothbrush containers, floss containers, periodontal brush handles or the use of both hands.

The disposable toothbrush, periodontal brush and flossing device is comprised of a flexible, four component dental hygienic care unit. One component is the flexible and longitudally elongated plastic handle portion. The second component is a brush portion of a small-headed toothbrush with two rows of ¼ to ½ inch bristles. The brush portion is angled to achieve easy accessibility to the back teeth without interference from the other end of the device.

The third component is the end that is double-pronged with a piece of tensioned dental floss held between the suitably distanced prongs (this component is also angled). The fourth component is the addition of the periodontal brush (which is a petite round-bristled brush that comes in various shapes) that is attached to the flossing element portion. The periodontal brush is flexible and can be moved in any direction to allow easy use of the device without it being in the way when the device is used as a toothbrush or flosser.

The device is made of a flexible but sturdy plastic (as that used for pocket combs) so that it can be stored in a pocket or purse without the risk of breaking.

### BRIEF DESCRIPTION OF THE DRAWINGS

FIG. 1 is an external view looking at the device with the bristles and the flossing device facing you. The flossing device is drawn detached as to provide definition of the flossing device and the attachment point of the periodontal brush.

FIG. 2 is an external side view of the complete item showing the positions of the four components.

FIG. 3 is an external view looking at the device from the opposite side of FIG. 1.

FIG. 4 is an external detached side view approximate dimensions and positions of the brush, flossing device and periodontal brush.

FIG. 5 is an external detached side view showing the angles of the periodontal brush and flossing device in relation to the handle.

FIG. 6 is a side view of the complete item, labeling the embodiments.

### DESCRIPTION OF THE PREFERRED EMBODIMENTS

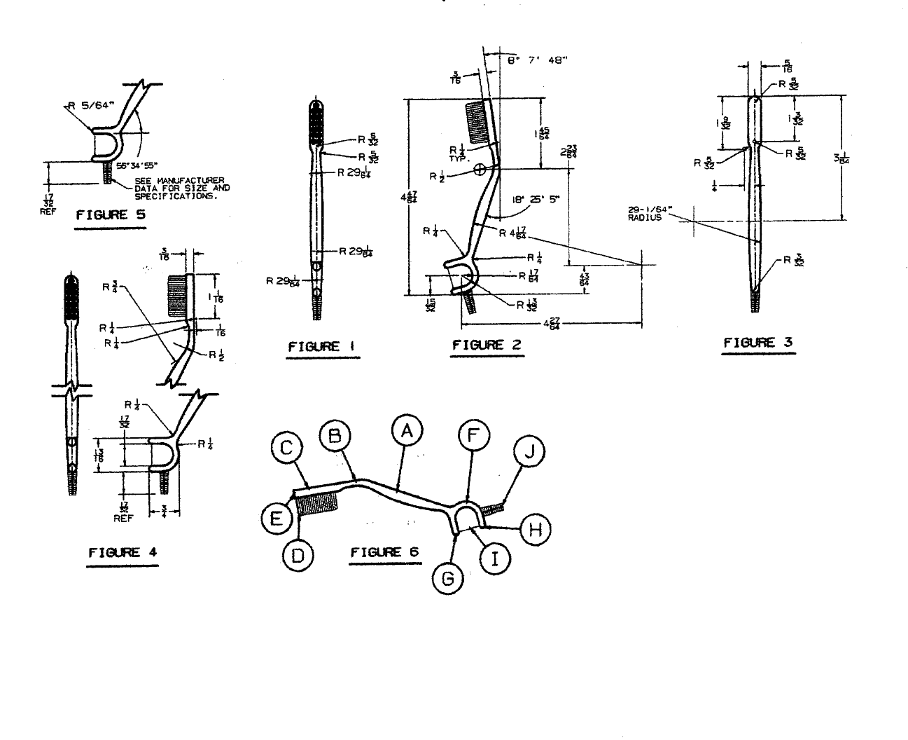

The disposable toothbrush A of this invention is shown in FIGS. 1, 2, 3, 4, 5 and 6, comprises a generally longitudinally elongated plastic handle portion B of mostly constant width whose diameter is sufficiently wide to be easily grasped by the hand, and small enough to minimize material and storage space, and is generally rectangular in cross section. A brush element C having a plurality of bristles D is mounted at one end E of the handle portion, and a floss portion is mounted at the opposite end F of the handle. The floss portion comprises twin fork elements G and H, and a flossing thread I mounted in between. The periodontal brush J is attached to the floss end.

Typically, the handle portion B is about 4″ long, ¼″ in width, and ⅛-¼″ thick; brush element C is about ¼″ wide, and 1 5/16″ long; the distance between the fork elements G and H, which determines the length of the flossing thread I, is about ⅜″-¾″ wide; and, the fork elements themselves are about ½″-¾″ long.

Overall, the disposable toothbrush and flossing portion provides a simplified and convenient means of flossing and brushing, encourages the performance of proper oral hygienic care, thereby reducing the risk of periodontal problems and disease.

I claim:

1. A four-component disposable toothbrush comprising:
a. a handle portion:
b. a bristle portion defining an attachment surface, and a free surface being embedded within the handle portion, the brush element portion being angled from the handle.
c. a flossing element portion that is angled from the handle; and,
d. the periodontal brush attached to the floss element portion.

2. The toothbrush of claim 1, in which the bristle portion comprises a plurality of bristles which are soft flexible materials selected from the class consisting of nylon, acrylic, polyester, and blends of these materials.

3. The toothbrush of claim 1, in which the plastic is flexible selected from the class consisting of nylon, acrylic, polycarbonate and polypropylene.

4. The toothbrush of claim 1, in which the flossing element portion contains the periodontal brush which is flexible as to move to other positions to aid in the easy cleaning of the plaque off the teeth and gums areas.

5. The toothbrush of claim 1, in which the toothbrush head and the flossing element portion are angled to provide easy access to the back teeth.

6. The toothbrush of claim 1, in which the handle portion dimensions are about 3½″-4″ long, ¼″ in width, and ⅛″-¼″ thick, the brush element is about ¼″-½″ wide, and ¾″-1¼″ in length, and the distance between the fork elements is about ⅜″-¾″ wide and ½″-¾″ in length.

7. The overall length from the brush end E to brush J is approximately 5 1/2″-6″.
The device can be used easily by the military members who are in the field for training or combat, providing a one-handed, easy-to-use complete dental care product that is conveniently stored inside (or attached to the outside by a sturdy plastic envelope) of the MRE for use immediately after eating.
The device can be used by almost everyone, including many disabled people who have the use of only one hand. It can be used by the American Red Cross in disaster-relief efforts, in hospitals, the Girl and Boy Scouts, camping trips, in airport vending machines, on airlines and at hotels.
